(19) United States
(12) Patent Application Publication
(10) Pub. No.: US 2007/0187372 A1
(43) Pub. Date: Aug. 16, 2007

(54) High enthalpy low power plasma reformer

(76) Inventors: Alexander Rabinovich, Swampscott, MA (US); Andrei Samokhin, Moscow Reg. (RU); Nikolai Alexeev, Moscow (RU); Alexander Peschkoff, London (GB)

Correspondence Address: CHOATE, HALL & STEWART LLP, TWO INTERNATIONAL PLACE, BOSTON, MA, 02110, US

(21) Appl. No.: 11/352,138

(22) Filed: Feb. 10, 2006

(51) Int. Cl. B23K 9/00; B01J 19/08

(52) U.S. Cl. 219/121.36; 422/186.03

(57) ABSTRACT

High enthalpy low power plasma reformer. An annular ground electrode includes a air intake manifold and helical structure for directing an air helically along the ground electrode in a heat transfer relation. A high voltage electrode is spaced from the ground electrode to create a gap through which preheated air flows, the high voltage electrode including a passage for delivery of hydrocarbon fuel to an atomizer. A plasma discharge occurs within an electric arc discharge region within the annular ground electrode in which the fuel is partially pyrolized to produce hydrogen rich gas.

### BACKGROUND OF THE INVENTION

This invention relates to plasma fuel reformers (plasmatrons) and more particularly to such plasmatrons that operate with high enthalpy and low power.

Plasma reformers, often referred to as plasmatrons, are well-known devices for reforming hydrocarbons to generate a hydrogen rich gas that includes hydrogen, carbon monoxide and light hydrocarbons through the use of a plasma discharge. Plasmatrons are known that use low current and high voltage discharges to provide significant advantages as described in U.S. Pat. No. 6,881,386 and published U.S. patent application 2005/0210877, of which some of the inventors of the present application are co-inventors. The contents of these patent documents are incorporated by reference herein.

It is often desired to operate plasmatrons in an “incomplete pyrolysis” mode, that is, at an oxygen/carbon ratio less than one. Known plasmatrons do not operate effectively in this mode because of the low temperature of the plasma stream. The known low power plasmatrons can operate at an O/C ratio of approximately one to produce a hydrogen rich gas including H₂, CO and N₂ with temperatures of approximately 900 degrees C. Higher temperatures can be achieved by increasing the O/C ratio to 3 or higher (complete combustion), but the product gas will contain mainly CO₂, H₂O and N₂ which is not desirable.

However, for some applications it is advantageous to operate a plasmatron at an O/C less than one (or an O/C much less than one, approaching zero) thereby producing H₂ as well as significant amounts of hydrocarbons according to the chemical reaction:
CₘHₙ→xH₂+CₘHₙ₋₂ₓ

A promising application for this mode of operation is the “selective catalytic reduction” of diesel exhaust emissions by hydrocarbons (SCR-HC).

Compared to other NOₓ elimination technologies, SCR-HC has the advantage of continuous operation and the use of hydrogen and hydrocarbons as the reducing agents.

The low power plasmatrons referred to above are usually employed as ignitors and therefore have low average enthalpy. For example, at a diesel flow rate of 0.1 g/s the amount of air required for partial oxidation at an O/C of approximately 1 would be approximately 25 liters per minute. At an average power of 200 W such operation corresponds to an enthalpy of approximately 0.47 MJ/m³. The average air temperature at this enthalpy would be approximately 300° C. If higher total flow rates were required, the enthalpy and corresponding air temperature would be even lower. To operate in the incomplete pyrolysis mode the temperature required for the destruction of hydrocarbons would be in the range of 1500-2000° C.

It is therefore an object of the present invention to provide a plasmatron capable of high enthalpy, low power operation in an incomplete pyrolysis mode.

### SUMMARY OF THE INVENTION

In one aspect, a high enthalpy, low power plasma reformer according to the invention includes an annular ground electrode including an air intake manifold and helical structure within the annular electrode for directing air helically upward along the ground electrode in a heat transfer relation to cool the electrode and to preheat the air. A high voltage electrode is spaced from the ground electrode to create a gap through which the preheated air flows, and the high voltage electrode includes a passage for delivering hydrocarbon fuel through an atomizer into an arc discharge region. The high voltage discharge is initiated in the gap between high voltage and grounded electrodes. The preheated air is injected through tangential channels to create swirl flow and to rotate and stretch the arc thus producing the volume discharge region. The fuel injected through the high voltage electrode with a flow rate up to 2 g/s is partially pyrolyzed to produce hydrogen rich gas in the electric arc discharge region within the annular ground electrode. In one embodiment, air is introduced into the air intake manifold at a rate in the range of 8-15 liters per minute. It is preferred for “partial pyrolysis” mode that the average temperature in the arc discharge region would be in a range of approximately 1500-2000° C. The hydrogen rich gas may include H₂, CH₄, CO, N₂ and hydrocarbons of C₂-C₄ groups (such as C₂H₂, C₂H₄, C₃H₆ etc.) In a preferred embodiment, the power is approximately 500 watts, the air flow rate is approximately 8 liters per minute and the enthalpy is approximately 3.7MJ/m³ that corresponds to a temperature of 2300° C.

In yet another preferred embodiment of this aspect of the invention, there is a downstream portion of the plasmatron including an air inlet for the introduction of additional air to achieve the desired overall oxygen/carbon ratio and to prevent soot formation.

In yet another aspect, a high enthalpy, low power plasma reformer includes a short annular ground electrode including an air intake manifold and the annular electrode includes structure for guiding air. A high voltage electrode is spaced from the ground electrode to create a gap through which the air flows and the high voltage electrode also includes a passage for delivering hydrocarbon fuel to an atomizer. The ground electrode forms an arc discharge region where the fuel is reformed. A further section downstream from the electric arc discharge region includes additional air and fuel (up to 2 g/s) introduction structure allowing generation of hydrogen rich gas with a desired total O/C ratio. The additional air and fuel also allows for production of hydrogen rich gas with selected composition (from deep pyrolysis at O/C<<1, to combustion at O/C>3) at a wide dynamic range of total flowrates. In a preferred embodiment of this aspect of the invention the short annular ground electrode has a length in the range of 5-10 mm. A preferred embodiment operates at an O/C ratio in the range of 1-1.6 at a fuel flow rate of approximately 0.1 g/s and an air flow rate of approximately 25 liters/min. An appropriate power level of operation is 500-700 watts. In this mode of operation the thermal effect of the partial oxidation reaction is added to the high enthalpy of the plasma stream.

In still another embodiment of this aspect of the invention, the annular ground electrode includes an insert made of a high temperature alloy. Water cooling may also be provided. In yet another embodiment the plasmatron further includes a thermally insulating section for reaction initiation and stabilization located between the electric arc discharge region and the further downstream section where additional air and fuel are introduced.

The high enthalpy, low power plasma reformers according to the invention provide better mixing of the air and fuel and decrease the likelihood of soot formation because of an increased rate of fuel vaporization, the volume of the air-fuel mixture and flow velocity in the reaction channel. Moreover, high flow velocities and temperatures improve fuel atomization. The higher enthalpy of the present designs allows ignition of an air-fuel mixture in a wide range of O/C ratios.

The present designs also create conditions conducive to a fast start of partial oxidation reactions (at O/C equals one) and the immediate production of hydrogen that is beneficial for other chemical processes, for example the HC-SCR process. An important advantage of the invention is that the designs disclosed herein allow for operation in an endothermic mode of incomplete pyrolysis at O/C ratios less than one. The plasmatron reformer designs disclosed herein provide for flexibility because the plasmatrons can operate in different modes: as a fuel vaporizer (O/C much less than one), “incomplete pyrolysis” (O/C less than one), or an oxidation reaction from partial oxidation up to complete combustion (O/C greater than or equal to one).

### BRIEF DESCRIPTION OF THE DRAWING

FIG. 1 is a cross-sectional view of an embodiment of a plasmatron of the invention.

FIG. 2 is a cross-sectional view of another embodiment of the invention.

FIG. 3 is a cross-sectional view of yet another embodiment of the invention.

### DESCRIPTION OF THE PREFERRED EMBODIMENT

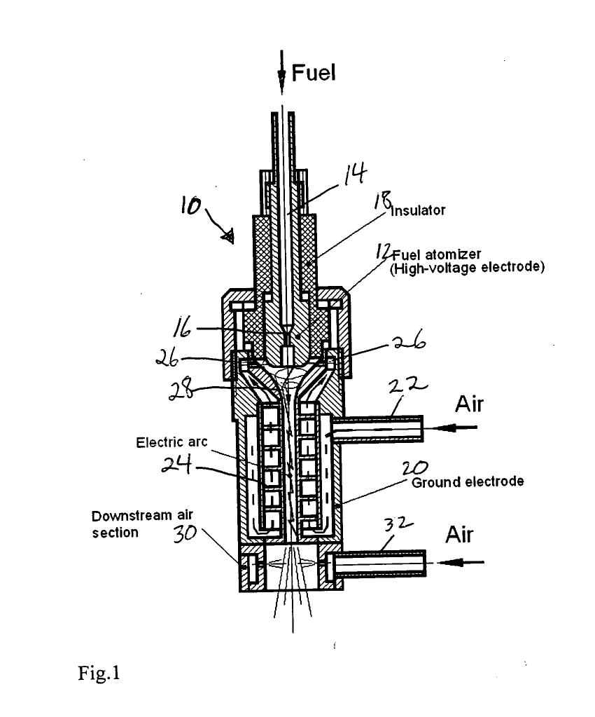

With reference first to FIG. 1, a high enthalpy, low power plasma reformer 10 includes a high voltage electrode 12 that includes a fuel passageway 14 with an atomizer section 16. The high voltage electrode 12 is surrounded by an insulator 18 that electrically insulates the high voltage electrode 12 from a ground electrode 20. The ground electrode 20 is an annular structure and includes an air inlet 22 and a helical or other similarly suitable structure 24 that directs air upwardly and through gaps 26 to mix with fuel in an arc discharge region 28. This embodiment also includes a downstream air section 30 including an additional air inlet 32.

In operation, plasma air, at a flow rate in the range of approximately 8-15 liters per minute, is injected into the ground electrode 20 through the air manifold 22 and is caused to revolve upwardly inside the ground electrode 20 by the helical structure 24 to provide efficient air cooling of ground electrode 20's inner surface (the air is, of course, preheated in the process). This preheated air is then injected into the gap 26 between the ground electrode 20 and the high voltage electrode 12 through tangential channels and creates a low power volume discharge in the region 28. The internal diameter of each of the channels is approximately 1-1.5 mm.

Liquid fuel with flow rate up to 2 g/s injected into the high speed plasma air stream (having an average temperature in the range of approximately 1500-2000° C.) is efficiently atomized, vaporized and partially pyrolyzed to produce hydrogen rich gas containing H₂, CH₄, CO, hydrocarbons of C₂-C₄ groups and N₂ Air cooling of the ground electrode in combination with the endothermic nature of the chemical reaction prevents excessive erosion of the ground electrode 20 surface.

Additional air may be injected through the manifold 32 into a downstream air section 30 if desired to correct total O/C ratio and to prevent soot formation. The plasmatron shown in FIG. 1 may also be operated in an alternate mode at very high fuel flow rates and O/C much less than one. This mode of operation will work as a very fast and efficient fuel vaporizer.

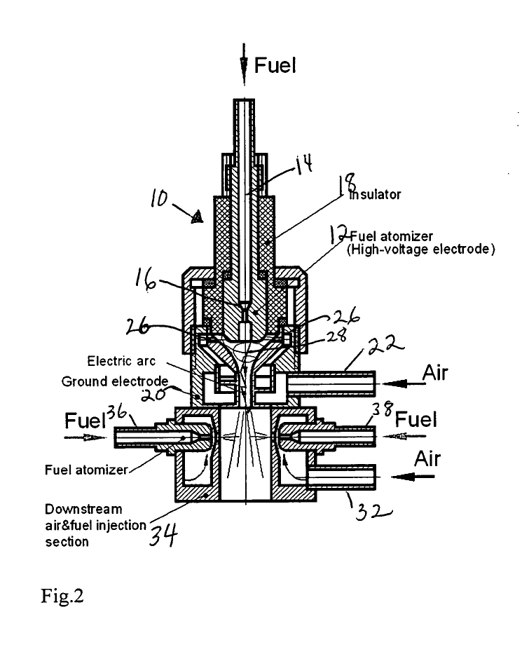

Another embodiment of the invention is shown in FIG. 2. In this embodiment, the ground electrode 20 is made very short, for example, not more than approximately 5-10 mm. By making the ground electrode 20 very short, heat flow to the ground electrode 20 wall and material melting are minimized. Further protection may be provided by the insertion into the ground electrode wall of an insert made of a high temperature alloy. Water cooling can also be provided if desired.

The embodiment of FIG. 2 includes a downstream air and fuel injection section 34 that includes an air manifold 32 and fuel injection structures 36 and 38. The additional fuel and air introduced in the downstream air and fuel injection section 34 produces hydrogen rich gas with a total O/C ratio less than one. It also allows for production of hydrogen rich gas of a selected composition at a wide range of total flowrates.

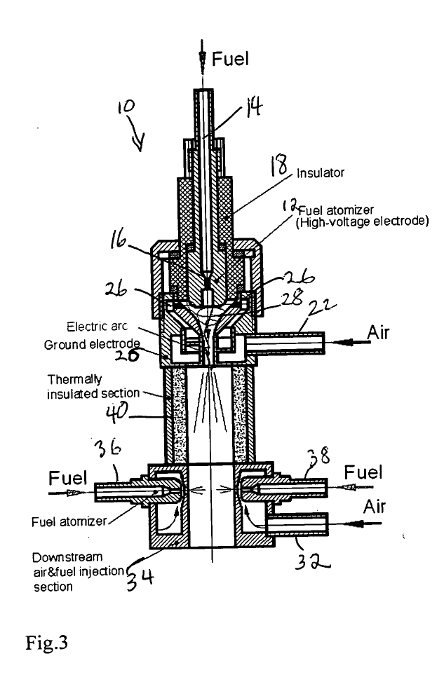

FIG. 3 is yet another embodiment of the invention and is similar to the embodiment in FIG. 2, but with the addition of a thermally insulated section 40 between the plasma discharge region 28 and the downstream air and fuel injection section 34. The thermally insulated section 40 aids in reaction initiation and stabilization.

The plasmatrons of the invention allow a high level of temperature to be achieved by significantly increasing electrical power with the simultaneous decrease of air flow rate. For example, at a power of 500 W and an airflow rate of 8 liters/min, the air enthalpy would be 3.7MJ/m³ and a temperature of 2300° C. In contrast, at a power level of 500 watts but with an air flow rate of 15 liters/min the enthalpy would drop to 2 MJ/m³ and the temperature would be reduced to 1400° C. Hot air velocity at these temperature levels would be in the range of 150-200 m/sec which is sufficient for adequate fine fuel atomization. In experiments, the inventors have been able to atomize up to 2 g/s of fuel with an excellent quality of atomization.

It is recognized that modifications and variations will occur to those of skill in the art and it is intended that all such modifications and variations be included within the scope of the appended claims.

What is claimed is:

1. High enthalpy low power plasma reformer comprising:
an annular ground electrode including an air intake manifold and helical or other suitable structure for directing air upward along the ground electrode in a heat transfer relation;
a high voltage electrode spaced from the ground electrode to create a gap through which preheated air flows, the high voltage electrode including a passage for delivering hydrocarbon fuel to an atomizer; and
an electric arc discharge region within the annular ground electrode in which the fuel is partially pyrolized to produce hydrogen rich gas.

2. The plasma reformer of claim 1 wherein air is introduced into the air intake manifold at a rate in the range of 8-15 liters/minute.

3. The plasma reformer of claim 1 wherein average temperature in the arc discharge region is in the range of approximately 1500-2000° C.

4. The plasma reformer of claim 1 wherein fuel is introduced into the arc discharge region with a flow rate up to 2 g/s.

5. The plasma reformer of claim 1 wherein the hydrogen rich gas includes H₂, CH₄, CO, hydrocarbons of C₂-C₄ groups and N₂.

6. The plasma reformer of claim 1 wherein power is approximately 500-700 watts;
air flow rate is approximately 8-15 liters/minute and the enthalpy is approximately 2-3.7 MJ/m³ at a temperature of 1400-2300° C.

7. The plasma reformer of claim 1 further including a downstream portion including an inlet for introduction of additional air to adjust total oxygen/carbon ratio and to prevent soot formation.

8. The plasma reformer of claim 6 wherein velocity of the preheated air is in the range of 150-200 m/sec.

9. High enthalpy low power plasma reformer comprising:
A short, annular ground electrode including an air intake manifold including structure for guiding air;
a high voltage electrode spaced from the ground electrode to create a gap through which the air flows, the high voltage electrode including a passage for delivering hydrocarbon fuel to an atomizer;
an electric arc discharge region within the annular ground electrode; and
a further section downstream from the electric arc discharge region including additional air and fuel introduction structure to generate hydrogen rich gas with a desired total O/C ratio.

10. The plasma reformer of claim 9 wherein the short annular ground electrode has a length in the range of 5-10 mm.

11. The plasma reformer of claim 9 operating at an O/C ratio in the range of 1-1.6 at a fuel flow rate of approximately 0.1 g/s and an air flow rate of approximately 25 liters/min.

12. The plasma reformer of claim 11 operating at a power level of 500-700 W.

13. The plasma reformer of claim 9 wherein the annular ground electrode includes an insert of a high temperature alloy.

14. The plasma reformer of claim 9 further including water cooling of the ground electrode.

15. The plasma reformer of claim 9 further including a thermally insulating section for reaction initiation and stabilization located between the electric arc discharge region and the further downstream section.

16. The plasma reformer of claim 9 wherein the fuel introduced into additional downstream section with a flow rate up to 2 g/s and the air introduced with a flow rate necessary to generate a hydrogen rich gas at selected O/C ratio.

17. The plasma reformer of claim 1 operating as a fuel vaporizer (at O/C ratio much less than 1).

18. The plasma fuel reformer of claim 1 operating at “incomplete pyrolysis” mode at (O/C ratio less than 1).

19. The plasma fuel reformer of claim 1 operating at oxidation mode (from partial oxidation to complete combustion at O/C ratio 1 and higher).
